(19) United States
(12) Patent Application Publication
(10) Pub. No.: US 2026/0031842 A1
(43) Pub. Date: Jan. 29, 2026

(54) RADIO RECEIVER WITH ADAPTIVE NOISE SUPPRESSION

(71) Applicant: Skyworks Solutions, Inc., Irvine, CA (US)

(72) Inventors: Carl Harry Alelyunas, Austin, TX (US); Alexander August Arthur Hakkola, Maple (CA)

(21) Appl. No.: 19/279,992

(22) Filed: Jul. 24, 2025

Related U.S. Application Data
(60) Provisional application No. 63/675,595, filed on Jul. 25, 2024.
(60) Provisional application No. 63/705,662, filed on Oct. 10, 2024.

(51) Int. Cl. H04B 1/10; H04L 27/26

(52) U.S. Cl. CPC H04B 1/1027; H04L 27/2634

(57) ABSTRACT

A radio receiver with noise floor estimation. The radio receiver includes a Fourier transform engine configured to convert a time domain audio signal into frequency domain blocks. The radio receiver further includes a spectral processing engine configured, for each frequency domain block, to generate a noise floor estimate using both (1) a stored noise profile corresponding to a component of the radio receiver and (2) magnitudes of the frequency domain block.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Technical Field

The disclosed technology relates to radio systems. Embodiments disclosed herein relate to noise reduction in an audio radio signal.

### Description of Related Technology

Radio technology involves transmitting signals in the radio spectrum. Radio receivers are implemented in a variety of applications. In addition to standalone radios for receipt of broadcast radio signals, a wide variety of devices can include a radio receiver (and often paired with a transmitter). Modem circuitry can be present in any device having wireless capabilities. Some broadcast radio signals are transmitted with analog coding (e.g., amplitude modulation (AM) and frequency modulation (FM) signals), and other terrestrial and satellite wireless communication systems use digital encoding. Example digital radio systems include systems that can be implemented in accordance with National Radio System Committee (NRSC-5C, also known as HD™ radio), Digital Audio Broadcasting (DAB), Digital Radio Mondiale (DRM), Convergent Digital Radio (CDR), or another suitable digital radio standard.

### SUMMARY

Suppressing noise in radio can be challenging, at least in part due to difficulties in estimating the noise floor. This can lead to undesirably aggressive attenuation where the noise floor estimate is too high, and undesirably high levels of noise where the noise floor estimate is too low.

Certain embodiments herein provide relatively accurate noise floor estimates. For example, some implementations generate noise floor estimates using a noise profile template or other type of noise characterization for a demodulator or other component(s) of the radio receiver for analog radio signals (e.g., AM or FM). Embodiments described herein can apply spectral processing techniques that utilize the noise floor estimates to suppress noise in an incoming audio signal.

Further aspects disclosed herein can detect and/or mitigate “spit” noise, which can include wideband adjacent channel noise that intrudes on an active desired channel.

Additional aspects disclosed herein implement a combination of (1) spectral noise suppression (e.g., using the noise floor estimation techniques described herein), and (2) spectrum-wide attenuation. Such a technique can be referred to as a “soft mute.”

In some aspects, the techniques described herein relate to a radio receiver with noise floor estimation, the radio receiver including: a Fourier transform engine configured to convert a time domain audio signal into frequency domain blocks; and a spectral processing engine configured, for each frequency domain block, to generate a noise floor estimate using both (1) a stored noise profile corresponding to a component of the radio receiver and (2) magnitudes of the frequency domain block.

In some aspects, the techniques described herein relate to a radio receiver wherein the spectral processing engine is further configured to generate the noise floor estimate by: for each frequency bin within the frequency domain block, calculating a value that is a function of (1) an entry in the stored noise profile corresponding to the frequency bin, and (2) a magnitude of the frequency domain block for the frequency bin, and identifying the calculated value for one of the frequency bins as the noise floor estimate for the frequency domain block.

In some aspects, the techniques described herein relate to a radio receiver wherein the spectral processing engine is further configured to low-pass filter the magnitude of the frequency domain block used in the calculation.

In some aspects, the techniques described herein relate to a radio receiver wherein the spectral processing engine is further configured to adjust the noise floor estimate based on a tonality metric derived from magnitudes of the frequency domain block.

In some aspects, the techniques described herein relate to a radio receiver wherein the tonality metric corresponds to a sum of squares of the magnitudes of the frequency domain block divided by a square of sums of the magnitudes of the frequency domain block.

In some aspects, the techniques described herein relate to a radio receiver wherein the spectral processing engine is further configured to: for each frequency bin within the frequency domain block, scale an output of the stored noise profile corresponding to the frequency bin by the noise floor estimate to generate a noise estimate; and based on the noise estimate, adjust a magnitude of the frequency domain block corresponding to the frequency bin.

In some aspects, the techniques described herein relate to a radio receiver wherein the spectral processing engine is further configured to filter the magnitude of the frequency domain block corresponding to the frequency bin in time and frequency.

In some aspects, the techniques described herein relate to a radio receiver wherein the spectral processing engine is further configured to: receive a signal-to-noise ratio metric; and in response to determining that the signal-to-noise ratio metric is above a threshold, generate the noise floor estimate using both (1) the stored noise profile corresponding to a component of the radio receiver and (2) the magnitudes of the frequency domain block.

In some aspects, the techniques described herein relate to a radio receiver wherein the spectral processing engine is further configured to, in response to determining that the signal-to-noise ratio metric is below the threshold, generate the noise floor estimate according to an alternative technique without using the stored noise profile.

In some aspects, the techniques described herein relate to a radio receiver wherein the stored noise profile corresponds to a demodulator of the radio receiver.

In some aspects, the techniques described herein relate to a method of estimating a noise floor a radio receiver, the method including: receiving a demodulated time-domain audio signal generated from a modulated radio frequency signal detected by an antenna; transforming the demodulated time-domain audio signal into frequency domain blocks; and for each frequency domain block, generating, in the radio receiver, a noise floor estimate using both (1) a stored noise profile corresponding to a component of the radio receiver and (2) magnitudes of the frequency domain block.

In some aspects, the techniques described herein relate to a method wherein transforming the demodulated time-domain audio signal into the frequency domain blocks includes performing Fourier transform operations.

In some aspects, the techniques described herein relate to a method wherein generating the noise floor estimate includes: for each frequency bin within the frequency domain block, calculating a value that is a function of (1) an entry in the stored noise profile corresponding to the frequency bin, and (2) a magnitude of the frequency domain block for the frequency bin; identifying the calculated value for one of the frequency bins as the noise floor estimate for the frequency domain block.

In some aspects, the techniques described herein relate to a method wherein the magnitude of the frequency domain block used in the calculation is low pass filtered.

In some aspects, the techniques described herein relate to a method further including adjusting the noise floor estimate based on a tonality metric derived from magnitudes of the frequency domain block.

In some aspects, the techniques described herein relate to a method wherein the tonality metric corresponds to a sum of squares of the magnitudes of the frequency domain block divided by a square of sums of the magnitudes of the frequency domain block.

In some aspects, the techniques described herein relate to a method further including: for each frequency bin within the frequency domain block, scaling an output of the stored noise profile corresponding to the frequency bin by the noise floor estimate to generate a noise estimate; and based on the noise estimate, adjusting a magnitude of the frequency domain block corresponding to the frequency bin.

In some aspects, the techniques described herein relate to a method further including filtering the magnitude of the frequency domain block corresponding to the frequency bin in time and frequency.

In some aspects, the techniques described herein relate to a method further including: receiving signal-to-noise ratio metric; and in response to determining that the signal-to-noise ratio metric is above a threshold, generating the noise floor estimate using both the stored noise profile corresponding to a component of the radio receiver and the magnitudes of the frequency domain block.

In some aspects, the techniques described herein relate to a method further including, in response to determining that the signal-to-noise ratio metric is below the threshold, generating the noise floor estimate according to an alternative technique without using the stored noise profile.

In some aspects, the techniques described herein relate to a method wherein the stored noise profile corresponds to a demodulator of the radio receiver.

In some aspects, the techniques described herein relate to a radio system with noise floor estimation, the radio system including: at least one antenna configured to receive a radio signal; and a radio receiver of any of the above embodiments or configured to implement any of the above methods.

In some aspects, the techniques described herein relate to a radio system further including a speaker in communication with the radio receiver.

In some aspects, the techniques described herein relate to a method of suppressing noise in an audio signal of a radio receiver, the method including: transforming a demodulated time-domain audio signal into frequency domain blocks; in the radio receiver, using a stored noise profile corresponding to a component of the radio receiver to generate noise floor estimates for the frequency domain blocks; for each of the frequency domain blocks, using the noise floor estimate for that frequency domain block to adjust an output of the stored noise profile to generate a noise estimate for the frequency domain block across frequencies; and using the noise estimate for each frequency domain block to adjust magnitudes of the frequency domain block across frequencies, thereby suppressing noise in the audio signal.

In some aspects, the techniques described herein relate to a method wherein transforming the demodulated time-domain audio signal into frequency domain blocks includes performing Fourier transform operations.

In some aspects, the techniques described herein relate to a method wherein generating the noise floor estimate includes: for frequency bins across the frequency domain block, calculating a value that is a function of (1) an entry in the stored noise profile corresponding to the frequency bin, and (2) a magnitude of the frequency domain block for the frequency bin; identifying the calculated value for one of the frequency bins as the noise floor estimate for the frequency domain block.

In some aspects, the techniques described herein relate to a method wherein the magnitude of the frequency domain block used in the calculation is low pass filtered.

In some aspects, the techniques described herein relate to a method further including adjusting the noise floor estimate based on a tonality metric derived from magnitudes of the frequency domain block.

In some aspects, the techniques described herein relate to a method wherein the tonality metric corresponds to a sum of squares of the magnitudes of the frequency domain block divided by a square of sums of the magnitudes of the frequency domain block.

In some aspects, the techniques described herein relate to a method further including for each frequency bin of each frequency domain block: filtering the magnitude of the frequency domain block in time and frequency to generate a filtered magnitude; and attenuating the magnitude of the frequency domain block according to a function of (1) the noise floor estimate for the frequency bin and (2) the filtered magnitude, thereby suppressing noise in the audio signal.

In some aspects, the techniques described herein relate to a method further including transforming the frequency blocks into time domain samples.

In some aspects, the techniques described herein relate to a method further including, in response to determining that a signal-to-noise ratio metric is below a threshold, generating the noise floor estimates for the frequency domain blocks according to an alternative technique without using the stored noise profile.

In some aspects, the techniques described herein relate to a method wherein the stored noise profile corresponds to a demodulator of the radio receiver.

In some aspects, the techniques described herein relate to a radio receiver with noise suppression including: a Fourier transform engine configured to convert a time domain audio signal into frequency domain blocks; and a spectral processing engine configured to use a stored noise profile corresponding to a component of the radio receiver to generate noise floor estimates for the frequency domain blocks and further configured to, for each of the frequency domain blocks, use the noise floor estimate for that frequency domain block to adjust an output of the stored noise profile to generate a noise estimate for the frequency domain block across frequencies, and to use the noise estimate for each frequency domain block to adjust magnitudes of the frequency domain block across frequencies, thereby suppressing noise in the audio signal.

In some aspects, the techniques described herein relate to a radio receiver further including an inverse Fourier transform engine configured to transform the frequency domain blocks into a time domain signal.

In some aspects, the techniques described herein relate to a radio receiver wherein the spectral processing engine is configured to generate the noise floor estimate by, for frequency bins across the frequency domain block, calculating a value that is a function of (1) an entry in the stored noise profile corresponding to the frequency bin, and (2) a magnitude of the frequency domain block for the frequency bin, and to identify the calculated value for one of the frequency bins as the noise floor estimate for the frequency domain block.

In some aspects, the techniques described herein relate to a radio receiver wherein the magnitude of the frequency domain block used in the calculation is low pass filtered.

In some aspects, the techniques described herein relate to a radio receiver wherein the spectral processing engine is configured to adjust the noise floor estimate based on a tonality metric derived from magnitudes of the frequency domain block.

In some aspects, the techniques described herein relate to a radio receiver wherein the tonality metric corresponds to a sum of squares of the magnitudes of the frequency domain block divided by a square of sums of the magnitudes of the frequency domain block.

In some aspects, the techniques described herein relate to a radio receiver wherein the spectral processing engine is further configured, for each frequency bin of each frequency domain block, to: filter the magnitude of the frequency domain block in time and frequency to generate a filtered magnitude; and attenuate the magnitude of the frequency domain block according to a function of (1) the noise floor estimate for the frequency bin and (2) the filtered magnitude, thereby suppressing noise in the audio signal.

In some aspects, the techniques described herein relate to a radio receiver wherein the spectral processing engine is further configured to, in response to determine that a signal-to-noise ratio metric is below a threshold, generate the noise floor estimates for the frequency domain blocks according to an alternative technique without using the stored noise profile.

In some aspects, the techniques described herein relate to a radio receiver wherein the stored noise profile corresponds to a demodulator of the radio receiver.

In some aspects, the techniques described herein relate to a radio system with noise suppression, the radio system including: at least one antenna configured to receive a radio signal; and a radio receiver of any of the above embodiments or configured to implement any of the above methods.

In some aspects, the techniques described herein relate to a radio system further including a speaker in communication with the radio receiver.

In some aspects, the techniques described herein relate to a method of suppressing noise in an audio signal of a radio receiver, the method including: receiving a demodulated audio signal generated from a modulated radio frequency signal detected by an antenna; generating frequency domain blocks from the demodulated audio signal; in the radio receiver, generating estimated noise floor values and generating a noise suppressed audio signal using the estimated noise floor values; detecting, in the radio receiver, satisfaction of a threshold condition for attenuating the noise suppressed audio signal; and in response to detecting the threshold condition, attenuating in the radio receiver the noise suppressed audio signal.

In some aspects, the techniques described herein relate to a method wherein detecting the threshold condition includes comparing the estimated noise floor values to a minimum threshold noise level.

In some aspects, the techniques described herein relate to a method wherein attenuating the noise suppressed audio signal includes limiting an amount of attenuation based on a maximum attenuation value.

In some aspects, the techniques described herein relate to a method wherein the estimated noise floor values are low-passed filtered before they are compared to the minimum threshold noise level.

In some aspects, the techniques described herein relate to a method wherein generating the estimated noise floor values includes using a stored noise profile corresponding to a component of the radio receiver.

In some aspects, the techniques described herein relate to a method wherein the stored noise profile corresponds to a demodulator of the radio receiver.

In some aspects, the techniques described herein relate to a method wherein generating the estimated noise floor values includes, for each frequency domain block of the frequency domain blocks, using both (1) the stored noise profile and (2) magnitudes of the frequency domain block.

In some aspects, the techniques described herein relate to a method wherein generating the estimated noise floor values includes: for each frequency bin within the frequency domain block, calculating a value that is a function of (1) an entry in the stored noise profile corresponding to the frequency bin, and (2) a magnitude of the frequency domain block for the frequency bin; and identifying the calculated value for one of the frequency bins as the noise floor estimate for the frequency domain block.

In some aspects, the techniques described herein relate to a method wherein transforming the demodulated audio signal into frequency domain blocks includes performing Fourier transform operations.

In some aspects, the techniques described herein relate to a radio receiver with noise detection including: a Fourier transform engine configured to convert a demodulated audio signal into frequency domain blocks; and a spectral processing engine configured to generate frequency domain blocks from the demodulated audio signal, generate estimated noise floor values, generate a noise suppressed audio signal using the estimated noise floor values, detect satisfaction of a threshold condition for attenuating the noise suppressed audio signal, and, in response to detecting the threshold condition, attenuate in the radio receiver the noise suppressed audio signal.

In some aspects, the techniques described herein relate to a radio receiver wherein the spectral processing engine detects satisfaction of the threshold condition by comparing the estimated noise floor values to a minimum threshold noise level.

In some aspects, the techniques described herein relate to a radio receiver wherein the spectral processing engine is configured to limit an amount of attenuation based on a maximum attenuation value.

In some aspects, the techniques described herein relate to a radio receiver wherein the estimated noise floor values are low-passed filtered before they are compared to the minimum threshold noise level.

In some aspects, the techniques described herein relate to a radio receiver wherein the spectral processing engine is configured to generate the estimated noise floor values includes using a stored noise profile corresponding to a component of the radio receiver.

In some aspects, the techniques described herein relate to a radio receiver wherein the stored noise profile corresponds to a demodulator of the radio receiver.

In some aspects, the techniques described herein relate to a radio receiver wherein the spectral processing engine is configured to generate the estimated noise floor values by, for each of the frequency blocks, using both (1) the stored noise profile and (2) magnitudes of the frequency domain block.

In some aspects, the techniques described herein relate to a radio receiver wherein the spectral processing engine is configured to generate the estimated noise floor values by performing operations including: for each frequency bin within the frequency domain block, calculating a value that is a function of (1) an entry in the stored noise profile corresponding to the frequency bin, and (2) a magnitude of the frequency domain block for the frequency bin; and identifying the calculated value for one of the frequency bins as the noise floor estimate for the frequency domain block.

In some aspects, the techniques described herein relate to a radio system with noise suppression, the radio system including: at least one antenna configured to receive a radio signal; and a radio receiver of any of the above embodiments or configured to implement any of the above methods.

In some aspects, the techniques described herein relate to a radio system further including a speaker in communication with the radio receiver.

In some aspects, the techniques described herein relate to a method of detecting noise in an audio signal of a radio receiver, the method including: transforming a time-domain audio signal into frequency-domain blocks; using a stored noise profile corresponding to a component of the radio receiver, generating in the radio receiver at least a first metric based on the frequency-domain blocks; and in the radio receiver, based on the first metric, detecting a presence of noise intruding into an active channel from another channel.

In some aspects, the techniques described herein relate to a method wherein the noise includes wideband short duration spit noise.

In some aspects, the techniques described herein relate to a method wherein the stored noise profile corresponds to a demodulator of the radio receiver.

In some aspects, the techniques described herein relate to a method wherein generating the first metric includes, for each frequency-domain block of the frequency-domain blocks, using the stored noise profile and values of the frequency-domain block across frequencies to generate a noise floor estimate for the frequency-domain block.

In some aspects, the techniques described herein relate to a method wherein generating the first metric further includes using low pass filtered versions of the values of the frequency-domain block across frequencies.

In some aspects, the techniques described herein relate to a method further including generating a second metric using at least the stored noise profile, and wherein the detecting the presence of the noise is based on at least the first metric and the second metric.

In some aspects, the techniques described herein relate to a method wherein generating the second metric includes performing a sum of deltas function based on values of the frequency-domain block and values of the stored noise profile across frequencies.

In some aspects, the techniques described herein relate to a method wherein detecting presence of the noise further includes: determining a first metric qualifying event based on a plurality of sequential instances of the first metric; determining a second metric qualifying event based on a plurality of sequential instances of the second metric; and detecting a presence of the noise in response to the determination of both the first metric qualifying event and the second metric qualifying event.

In some aspects, the techniques described herein relate to a method further including, in response to detecting the presence of the noise, masking one or more first frequency-domain samples that are in proximity of the noise to mitigate the noise.

In some aspects, the techniques described herein relate to a method wherein the masking includes overwriting values of at least one first frequency-domain block associated with the noise with values of at least one other frequency-domain block not associated with the noise.

In some aspects, the techniques described herein relate to a method wherein the at least one other frequency-domain block is an earlier frequency-domain block than the first frequency-domain block.

In some aspects, the techniques described herein relate to a method wherein masking the at least one first frequency-domain block includes masking magnitudes of the at least one first frequency-domain block while leaving phases of the at least one frequency-domain block unmodified.

In some aspects, the techniques described herein relate to a method wherein transforming the time-domain audio signal into frequency-domain blocks includes performing Fourier transform operations.

In some aspects, the techniques described herein relate to a radio receiver with noise detection including: a Fourier transform engine configured to convert a time-domain audio signal into frequency-domain blocks; and a spectral processing engine configured to, using a stored noise profile corresponding to a component of the radio receiver, generate in the radio receiver at least a first metric based on the frequency-domain blocks, and based on the first metric, detect a presence of noise intruding into an active channel from another channel.

In some aspects, the techniques described herein relate to a radio receiver wherein the noise includes wideband short duration spit noise.

In some aspects, the techniques described herein relate to a radio receiver wherein the stored noise profile corresponds to a demodulator of the radio receiver.

In some aspects, the techniques described herein relate to a radio receiver wherein the spectral processing engine generates the first metric by, for each frequency-domain block, using the stored noise profile and values of the frequency-domain block across frequencies to generate a noise floor estimate for the frequency-domain block.

In some aspects, the techniques described herein relate to a radio receiver wherein the spectral processing engine generates the first metric using low pass filtered versions of the values of the frequency-domain block across frequencies.

In some aspects, the techniques described herein relate to a radio receiver wherein the spectral processing engine is further configured to generate a second metric using at least the stored noise profile, and to detect the presence of the noise based on at least the first metric and the second metric.

In some aspects, the techniques described herein relate to a radio receiver wherein the spectral processing engine generates the second metric by performing operations including a sum of deltas function based on values of the frequency-domain block and values of the stored noise profile across frequencies.

In some aspects, the techniques described herein relate to a radio receiver wherein the spectral processing engine is configured to detect presence of the noise by performing operations including: determining a first metric qualifying event based on a plurality of sequential instances of the first metric; determining a second metric qualifying event based on a plurality of sequential instances of the second metric; and detecting presence of the noise in response to the determination of both the first metric qualifying event and the second metric qualifying event.

In some aspects, the techniques described herein relate to a radio receiver wherein the spectral processing engine is further configured, in response to detecting the presence of the noise, to mask one or more first frequency-domain samples that are in proximity of the noise to mitigate the noise.

In some aspects, the techniques described herein relate to a radio receiver wherein the spectral processing engine is configured to overwrite values of at least one first frequency-domain block associated with the noise with values of at least one other frequency-domain block not associated with the noise.

In some aspects, the techniques described herein relate to a radio receiver wherein the at least one other frequency-domain block is a frequency-domain block from before the first frequency-domain block.

In some aspects, the techniques described herein relate to a radio receiver wherein the spectral processing engine is configured to mask magnitudes of the at least one first frequency-domain block while leaving phases of the at least one frequency-domain block unmodified.

In some aspects, the techniques described herein relate to a radio system with noise detection, the radio system including: at least one antenna configured to receive a radio signal; and a radio receiver of any of the above embodiments or configured to implement any of the above methods.

In some aspects, the techniques described herein relate to a radio system further including a speaker in communication with the radio receiver.

### BRIEF DESCRIPTION OF THE DRAWINGS

Embodiments of this disclosure will now be described, by way of non-limiting example, with reference to the accompanying drawings.

FIG. 1A is a schematic diagram of an example radio system according to an embodiment.

FIG. 1B shows another example of a radio system.

FIG. 2 shows a portion of a radio receiver that includes a spectral noise reduction system.

FIG. 3 shows an example of a spectral noise reduction system.

FIG. 4 shows a noise floor scaler generator.

FIG. 5 shows an example of a spectral processing block that implements adaptive noise suppression.

FIG. 6 shows another embodiment of a noise floor scaler generator.

FIG. 7 shows a portion of a spectral processing block that adjusts the noise floor scalar based on a tonality metric.

FIG. 8 shows an example of a noise floor estimator that can be used in a spit reduction process.

FIG. 9A illustrates an example of a first portion of a spit detector configured to generate first and second metrics.

FIG. 9B illustrates an example of a second portion of the spit detector configured to process the first and second metrics to determine whether a spit is present.

FIG. 10A shows an example of a spit mitigator.

FIG. 10B illustrates operation of the spit mitigator during normal operation where no spit is detected.

FIG. 10C illustrates operation of the spit mitigator over the course of six time blocks t0−4 to t0+1 for a scenario where a spit is detected at time block t0−3.

FIG. 11 shows an example of an audio processing system that employs adaptive noise suppression and soft mute.

FIG. 12A illustrates an example of a plot of a noise profile for a radio component configured to process a frequency modulated (FM) signal.

FIG. 12B illustrates an example of a plot of a noise profile for a radio component configured to process an amplitude modulated (AM) signal.

FIG. 13 is a schematic block diagram of a radio baseband processor according to an embodiment.

### DETAILED DESCRIPTION OF CERTAIN EMBODIMENTS

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

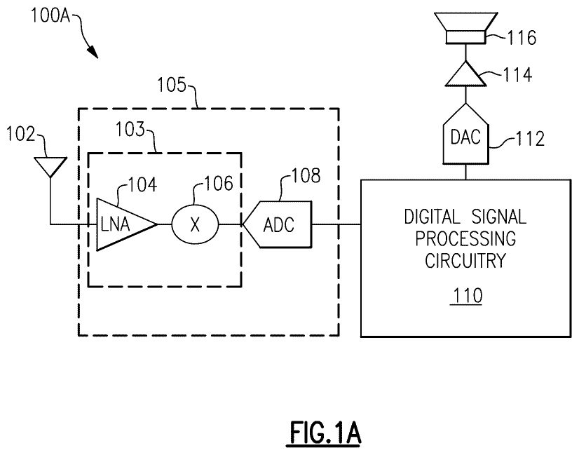

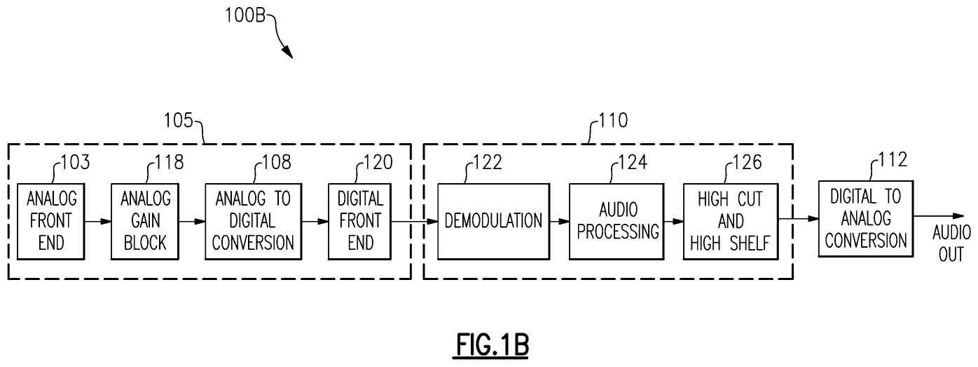

FIG. 1A is a schematic diagram of an example radio system 100A according to an embodiment. The radio system 100A can receive and process a radio signal. The radio system 100A can generate audio from the radio signal. The radio system 100A can process an analog radio signal transmitted with analog coding, such as an AM or FM signal. In certain alternative embodiments, the radio system 100A can process a digital radio signal that is in accordance one or more suitable digital radio standards, such as one or more of National Radio System Committee (NRSC-5C, also known as HD™ radio), Digital Audio Broadcasting (DAB), Digital Radio Mondiale (DRM), CDR, or another digital radio standard. As illustrated, the radio system 100A includes an antenna 102, an analog front end (AFE) 103, an analog-to-digital converter (ADC) 108, digital signal processing circuitry 110, a digital-to-analog converter (DAC) 112, an amplifier 114, and a speaker 116. As shown, the analog front end 103, the ADC 108, and/or one or more appropriate additional components can together form a radio frequency front end 103.

The radio system 100A can process a received radio signal in accordance with any suitable principles and advantages disclosed herein. The digital signal processing circuitry 110 can perform adaptive noise cancellation, spit reduction, and/or soft mute in accordance with any suitable principles and advantages disclosed herein.

The radio system 100A can be configured for receiving and processing FM or OFDM radio signals, for example. The digital processing system 110 can be implemented in software and/or firmware executing on one or more microprocessors, custom hardware (e.g., custom circuitry), or a combination thereof. For example, the processing system or portions thereof can be implemented in an application-specific integrated circuit (ASIC), a general purpose central processing unit (CPU), or a digital signal processor (DSP), or some combination of the three.

With reference to the radio system 100A of FIG. 1A, a radio frequency signal that includes radio signals according to a given broadcast specification (e.g., AM or FM) can be received via the antenna 102. In some instances, the radio frequency signal can be received via two or more antennas.

A radio frequency signal received via the antenna 102 can be processed by a receive signal path and provided to the digital signal processing circuitry 110. The radio frequency signal path includes the analog front end 103, which can include various components such as the illustrated low noise amplifier (LNA) 104 and mixer 106. The analog front end 103 can include other appropriate components such as one or more radio frequency filters.

The illustrated receive signal path further includes an analog to digital converter 108 and an analog-to-digital converter 112.

During operation, the LNA 104 can amplify the radio frequency signal received by the antenna 102. The amplified RF signal can be downconverted by the mixer 106. The downconverted signal generated by the mixer 106 can be a low-intermediate frequency (IF) signal or a zero-IF signal, for example. The downconverted signal can include an in-phase/quadrature phase (IQ) signal. The ADC 108 can digitize the downconverted signal into a digital signal.

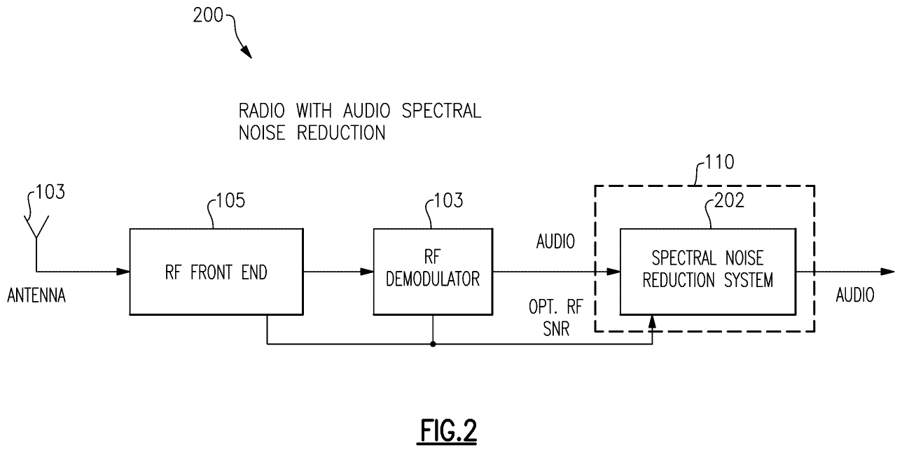

The digital signal processing circuitry 110 can perform any suitable processing on the digitized signal provided by the ADC 108. For example, the digital signal processing circuitry 110 can perform processing described with reference to one or more of FIGS. 2-11. The digital signal processing circuitry 110 can perform adaptive noise reduction, spit reduction, and/or soft mute in accordance with any suitable principles and advantages disclosed herein. The digital signal processing circuitry 110 can generate a digital audio output signal.

The audio output signal can be converted from a digital signal to an analog signal by a digital-to-analog converted (DAC) 112. The amplifier 114 can amplify the analog audio signal, which can be provided to a speaker 116 that transduces the amplified signal to audible output audio. While one speaker is shown in FIG. 1A, audio can be output from any suitable number of speakers based on one or more audio signals provided by the digital signal processing circuitry 110.

In some instances, the radio frequency signal path can include additional circuit elements, such as one or more filters, one or more amplifiers with automatic gain control, etc. For example, FIG. 1B shows another example of a radio system 100B in which the illustrated radio frequency front end further includes an analog gain block 118 and a digital front end 120.

The analog gain block 118 can amplify or attenuate the analog signal as needed to provide a signal with a suitable signal range (e.g., range that reduces or eliminates clipping or other distortion of the received signal) for subsequent circuitry of the receiver 100. A gain applied by analog gain block 118 may amplify or attenuate the analog signal to achieve a target dynamic range, for example. The digital front end 120 can implement functions such as a down-conversion, sample rate conversion, and channelization.

As shown, the digital signal processing circuitry 110 can include a demodulator 122 that can be configured to recover the original modulation from the carrier signal and output a demodulated digital signal. The audio processor 124 that can be configured to process the demodulated digital signal to perform functions like adaptive noise reduction, spit reduction, and/or soft mute.

The digital signal processing circuitry 110 can further include a filter block 126 that can be configured to perform functions like high shelf filtering to attenuate frequencies above a certain frequency point and high cut filtering to block frequencies above a certain frequency cutoff point, although other types of filtering can be used (e.g., low cut, low shelf, bell curve, bandpass, notch, etc.).

### Adaptive Audio Noise Suppression

FIG. 2 shows a portion of a radio receiver 200 that includes a spectral noise reduction system 202. The spectral noise reduction system 202 can be implemented in software or firmware executing on one or more processors of the receiver 200, for example. In some embodiments, the noise reduction system 202 is at least partially implemented in custom circuitry. As shown, the spectral noise reduction system 202 can optionally receive a radio frequency signal-to-noise signal ratio (SNR) indication from either the RF front end 105 or the RF demodulator 103, depending on the embodiment, and use the SNR calculation in the noise reduction process.

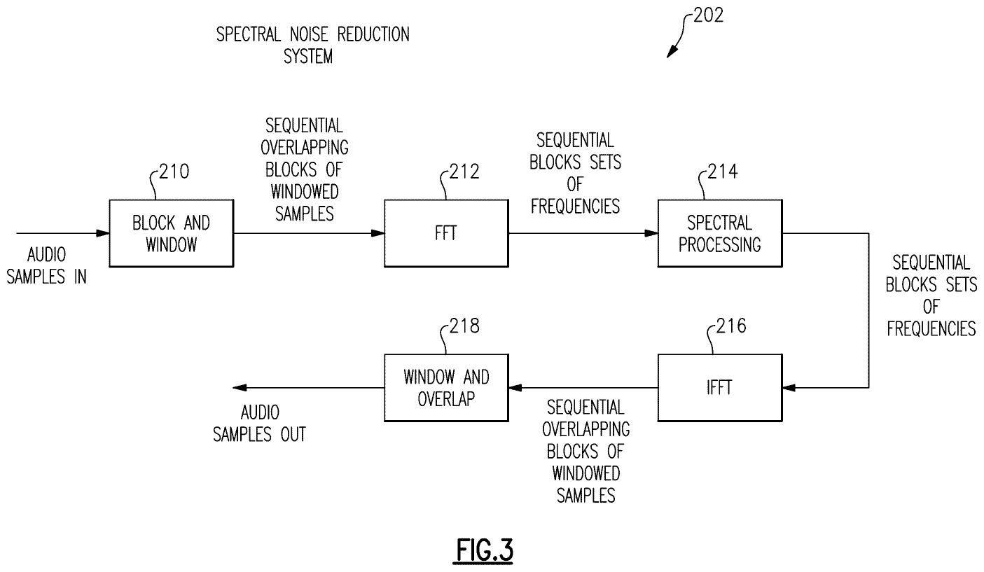

FIG. 3 shows an example of a spectral noise reduction system 202. The spectral reduction system 202 can be configured to estimate the noise floor by leveraging an assumption that for a given radio front-end, the spectral profile of the noise floor only changes in amplitude, not in frequency. Depending on the embodiment, the spectral reduction system can estimate the amplitude by using the real-time knowledge of channel signal to noise ratio (SNR) from the tuner, or by using the minimum value over frequency of the current amplitude divided by the noise floor template.

The spectral reduction system 202 includes a block and window block 210, a fast Fourier transform (FFT) block 212, a spectral processing block 214, an inverse FFT (IFFT) block 216, and a window and overlap block 218.

The block and window block 210 divides a stream of time-domain audio samples into processing blocks of windowed overlapping regions of samples. Each block can correspond to a group of samples over a sample window. In some exemplary implementation, the sample window spans about 43 ms and corresponds to 2048 samples taken at 48 kilohertz (e.g., 2048/48,000=42.67 ms). The FFT block 212 takes the FFT on each block to create multiple blocks of frequency-domain samples. The spectral processing block 214 performs adaptive noise reduction using spectral processing, which will be described in more detail herein, on the frequency blocks. The IFFT block 216 then applies an IFFT to each block, thereby converting the processed, noise reduced frequency-domain samples back into time-domain samples.

The window and overlap block 218 windows and sums the resulting blocks of time-domain samples to form a stream of time-domain samples. The windowing and overlap are chosen so that, if no processing is done between the FFT and IFFT, the original samples or substantially the original samples will result. For example, the window and overlap block 218 can apply a Hann window (e.g., a half-cycle sine wave) to the time-domain samples at both the FFT and IFFT.

One technique for reducing noise is spectral subtraction, where if the magnitude of the bin is less than the noise level, the bin is zeroed (or multiplied by a small number), else the bin is unchanged. But in situations where the actual noise level randomly and transiently exceeds the noise floor in isolated locations in time and frequency, artifacts commonly referred to as “musical noise” can arise. To help mitigate musical noise, frequency domain Weiner filtering may be used to make a smoother transition from a suppressed tone to an unsuppressed tone. Weiner filtering can involve applying a gain of (S/(S+N)) to each bin, where S is the desired signal and N is the noise of each bin. (S+N) is the magnitude of the received signal and noise, and S may be approximated by (S+N)−N*, where N* is the magnitude of the predetermined noise floor.

However, the accuracy of the noise reduction can be highly dependent on the noise floor estimate, which can be difficult to accurately determine. If the noise floor estimate is too low, there will be appreciable musical noise. If the noise floor estimate is too high, elements of the desired signal will be unacceptably attenuated.

One way to determine the noise floor is to use a magnitude negative peak detector on each frequency, where the noise floor magnitude estimate is the lowest value that each frequency takes, over time. This can be quite effective for a speech signal, where the spectrum is sparse and varying, and silence occurs between words. Music, however, can cause an overestimation of noise since the bin magnitudes won't all achieve their minima in a reasonable amount of time. This can cause unacceptable distortion to the music, typically eliminating reverb and harmonics from the audio.

According to certain embodiments described herein, the spectral processing system 214 accurately determines the noise floor estimate using spectral subtraction, Weiner filtering techniques, and/or using an additional method for suppressing musical noise using time and frequency filtering of the signal used for determining the gain of each frequency bin.

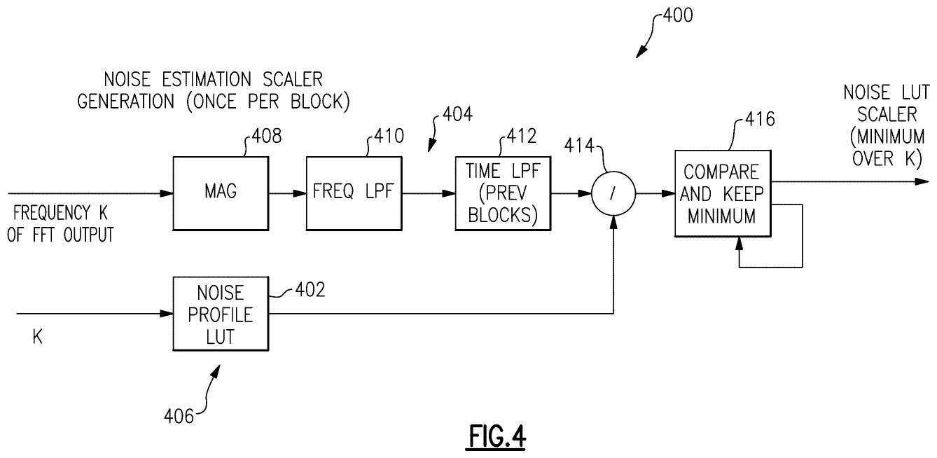

FIG. 4 shows a noise floor scaler generator 400 of a spectral processing block, such as the spectral processing block 214 of FIG. 3. The scaler generator 400 generates a noise estimation scaler for each frequency K across the block of samples represented by the current FFT output.

The noise floor scaler generator 400 includes a noise profile lookup table (LUT) 402, which stores a pre-determined template noise estimate in a memory for the receiver or a component thereof (e.g., of an RF demodulator), where the template includes a noise estimate for each frequency K. Because the noise in the audio spectrum of a signal demodulated from an RF signal (AM or FM) can be primarily dependent on the characteristics of the RF receiver (or a component thereof), using a predetermined noise profile characterized for the receiver can provide good results. Indeed, while the absolute level of the audio noise will be dependent on the noise in the RF signal, the spectrum of the audio noise will have the same overall shape for a given receiver implementation. This can be desirable because it allows for use of a known spectral profile to estimate the entire noise, in contrast to techniques that estimate the noise profile for each frequency bin. The noise profile can be static or dynamic depending on the embodiment. In some embodiments, the noise profile is initially written to an on-chip memory during fabrication. Depending on the implementation, the noise profile can be updated in the field as part of a software or firmware update. The noise profile can be generated by characterizing the noise response of a target component across frequencies using a variety of techniques, including those that use a power spectral distribution (PSD).

The scaler generator 400 includes a first path 404. The magnitude 408 of the FFT output for the current frequency bin K is provided to a frequency low pass filter block 410. The low pass filtered magnitude is provided to a time low pass filter 412, which filters in time based on previous blocks. The frequency and time filtering can smooth transient variations due to the noisy nature of the minima in the spectral magnitude. The low pass filter blocks 410, 412 can apply first order filters to each bin K, although other types of filters including higher order filters can be used in other implementations.

The generator 400 further includes a second path 406 that outputs the value in the noise profile LUT 402 corresponding to the current frequency bin K. For instance, according to some implementations, the noise LUT 402 can include an amplitude corresponding to each frequency bin K of an audio signal created when pure noise is injected into the radio receiver.

The scaler generator 400 divides (414) the output of the frequency and time filtered FFT magnitude value for each frequency K provided by the first path 404 by the noise LUT 402 for each frequency K provided by the second path 406. The scaler generator 400 at block 416 compares the divided value to the previous minimum value and determines and outputs the minimum value over all frequencies. The minimum over all frequencies K of the current time block of frequencies is the Noise LUT scaler for that time block of frequencies, and represents the level by which all entries of the noise LUT, for that time block of frequencies, should be scaled to create a noise estimate. In this fashion, the scaler generator 400 determines a scaler corresponding to the overall noise floor for that current block of frequencies because the floor will generally correspond to the minimum ratio for that current block of frequencies. The minimum scaler, which can represent the noise floor of the one frequency that may not have additional signal imposed, or has relatively little additional signal imposed, is used to scale the FFT values across all frequencies in that time block of samples because the minimum scaler represents the noise floor estimate for all frequencies for that time block of samples.

The noise profile LUT 402 can be a noise profile characterized for a demodulator (e.g., the RF demodulator 103 of FIG. 2), which can be a demodulator of a radio system used in automotive applications. In other embodiments, the noise profile LUT 402 is that of a different component of the radio system. For instance, the noise profile LUT 402 can be that of a filter such as a dominant filter of the radio system that limits wideband audio.

In some cases, the noise profile LUT 402 can change dynamically. For example, in one embodiment, a channelization filter of the radio system is configurable by users, and the system updates the noise profile LUT 402 based on the channelization filter settings, e.g., based on metrics detected by the receiver. In another embodiment, the system can update the noise profile LUT 402 based on a high cut filter and/or high shelf filter setting.

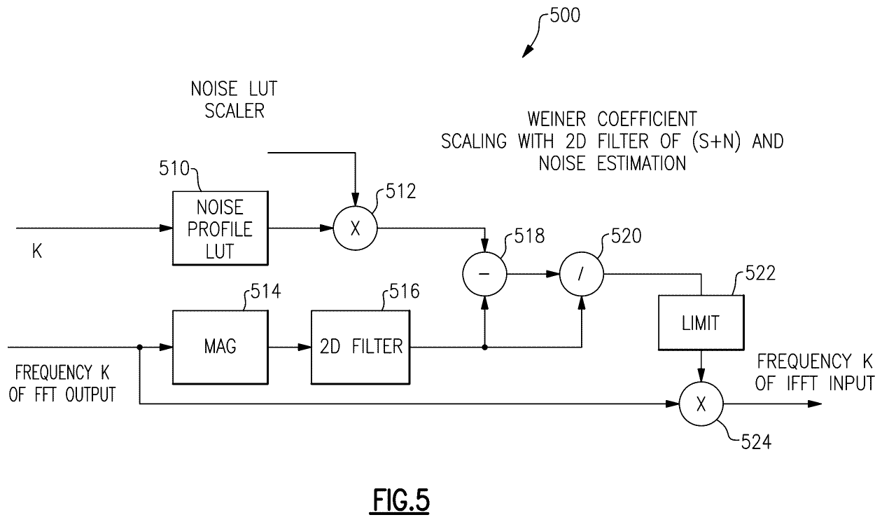

FIG. 5 shows an example of a spectral processing block 500, which may form part of the spectral processing block 214 of FIG. 3, and which can use a noise estimation scaler generated using the scaler generator 400 of FIG. 4.

The spectral processing block 500 can implement a Weiner filter with 2D gain filtering, where the magnitude is taken for each FFT bin. The magnitude is filtered in two dimensions, in time and frequencies.

In some example implementations, 2048 frequencies are generated by the FFT for a sample rate of 48000 Hz, and the filter is a box-car filter of three blocks in time and five frequencies, where all fifteen frequency/time points are averaged, and the current frequency/time point is at the center of the averaging in frequency and time. The amount of time and frequency the 2D filter spans in such embodiments can be chosen for best perceived audio quality, and can be any number of blocks and bins from minimum of 1×1 (no filtering). This filtering can further reduce the probability of a single noise point exceeding the threshold and creating “musical noise”.

The Noise Profile LUT 510, which can be the same as the Noise Profile LUT 402 of FIG. 4, and characterized for the same receiver, outputs a stored value corresponding to the noise profile for a current frequency bin K of the current FFT output. The spectral processing block 500 scales/multiplies (512) the output of the Noise Profile LUT 402 for the current frequency bin K by the Noise LUT scaler corresponding to the estimated noise floor (e.g., the scaler determined by the scaler generator 400 of FIG. 4).

The spectral processing block 500 additionally takes the magnitude (514) of the FFT output for the current frequency bin K and, with the 2D filter block 516, filters the magnitude. The 2D filter 516 can reduce musical noise by removing random isolated tones that may be introduced above the noise estimate. The 2D filter 516 can generally filter in time and frequency over several different frequencies and over multiple blocks of frequencies to reduce musical noise. This can come with an acceptable tradeoff of sacrificing some frequency or temporal resolution.

The filtered magnitude is subtracted (518) from the scaled output of the Noise Profile LUT. The result is divided (520) by the filtered magnitude and limited by the limiting block 522 to create a scaler for the frequency bin. The current frequency bin is multiplied/scaled (524) by the scaler and aggregated with all the other scaled frequency bins and provided to the IFFT input. These operations can generally serve to scale each frequency bin by (S−N*)/N* to achieve a maximum total SNR.

The limiter 522 limits the maximum amount of attenuation of each frequency bin to further reduce the perception of “musical noise,” which can be masked by actual audio noise already present in the signal or added synthetically.

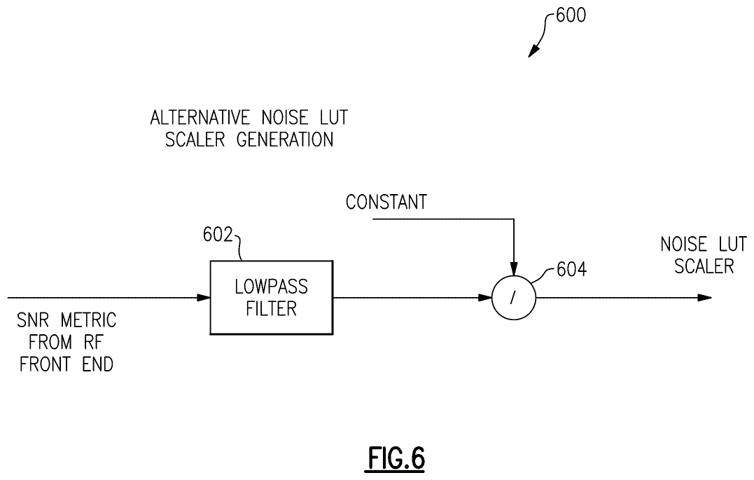

FIG. 6 shows an alternative scaler generator 600, which can be an alternative to the scaler generator 400 of FIG. 4 for generating the Noise LUT Scaler, for example.

The scaler generator 600 can receive an radio frequency SNR metric, which can be taken from or calculated by the radio front end. The radio front end or other appropriate component can calculate the SNR by comparing a received signal strength indicator (RSSI) versus a measured noise signal. The scaler generator 600 filters the SNR metric using a low pass filter, inverts the filtered value, and then multiplies the filtered, inverted value by a constant to generate the Noise LUT scaler. If the SNR indicates that there is substantial noise (relatively low SNR), dividing by the constant will increase the scaler, thereby effectively increasing the estimated noise floor. A high SNR can indicate that a specific audio signal is causing an erroneously relatively high noise estimate, and dividing by the constant can adjust the scaler downwards. This can prevent unwanted removal of desired portions of the signal, and can be useful for frequency rich audio sources like drums, cymbals, and electronic music, for example.

In some embodiments, the spectral processing block 214 uses a combination of the scaler generator 400 of FIG. 4 and the scaler generator 600 of FIG. 6. For instance, the scaler generator 400 of FIG. 4 can be particularly useful when there is relatively strong/good SNR, because the scaler generator 400 of FIG. 4 can result in a more precise estimate of the noise floor. But where there is relatively low SNR the scaler generator 600 of FIG. 6 can be relatively more useful. Thus, the spectral processing block 214 in some embodiments can determine whether the SNR is lower than a threshold. If the SNR is lower than the threshold, the spectral processing block 214 uses the scalers generated by the scaler generator 600 of FIG. 6. If the SNR is higher than the threshold, the spectral processing block 214 uses the scalers generated by the scaler generator 400 of FIG. 4. Moreover, the scaler generator 600 of FIG. 6 can be relatively more useful when there is fast interruption (e.g., where there is channel changing or spit noise), because the scaler generator 600 of FIG. 6 can operate relatively fast without having to run a loop filter, unlike the scaler generator of FIG. 4. In such an embodiment, in addition to or instead of performing the SNR threshold check, the spectral processing block 214 can detect whether there is a channel change detected and/or a threshold amount of spit noise present. If so, the spectral processing block 214 uses the scaler generator 600 of FIG. 6. If not, the spectral processing block uses the scaler generator 400 of FIG. 4.

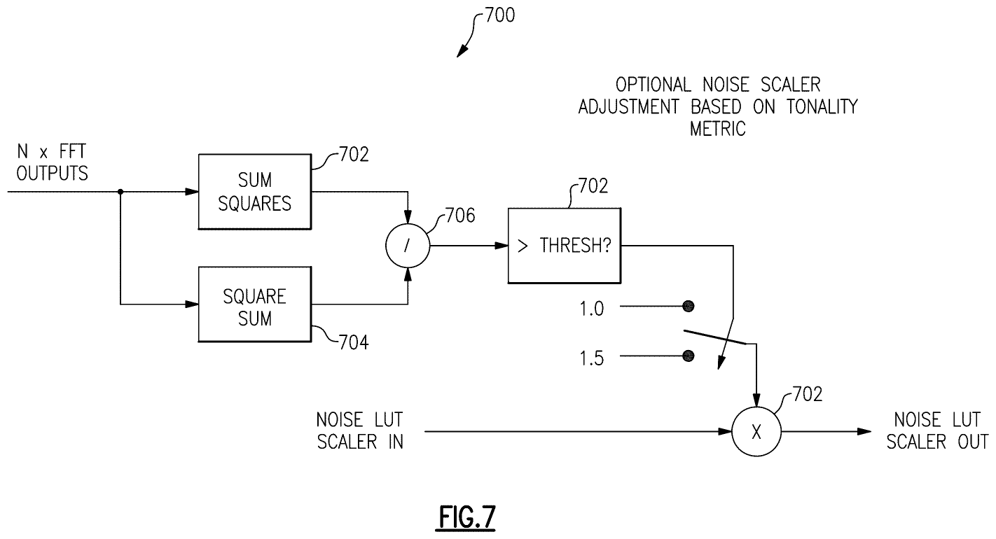

FIG. 7 shows a technique that can be implemented by the spectral processing block 214 to modify the Noise LUT scaler by a factor generated from a tonality metric. The tonality metric is the sum of squares (702) of the frequency magnitudes divided (706) by the square of the sums (704). In the case of pure noise, the tonality metric can very close to unity, because the sum of squares and square of sums will be the same, but the tonality metric can become large if there is any tonality, indicating voice, music or a signaling tone. The tonality metric is compared (702) to a threshold, and if it is less than the threshold, the Noise LUT Scaler is increased by a factor. In some embodiments of 48,000 Hz sampled audio from an AM receiver with 2048 frequency bins, the threshold can be 10, and a factor of increasing the noise floor can be 1.5. This can have the effect of minimizing the occurrence of “musical noise” in a time block where the lack of tonality indicates mostly noise.

Spectral Spit Reduction of Audio Demodulated from Frequency Modulated (FM) Radio

Certain embodiments are configured to reduce the occurrence of “spits” in audio signals. “Spits” are short duration occurrences of wideband noise caused by an adjacent frequency modulated (FM) channel intruding into the active bandwidth of the desired channel, causing a momentary loss of signal to noise ratio.

According to certain aspects, systems and methods disclosed herein detect and mitigate those “spits” using overlapping time-domain blocks of samples converted to the frequency domain. The blocks are compared spectrally and when a “spit” is detected, the frequency-domain audio from before and after the “spit” are used to replace the affected blocks of audio.

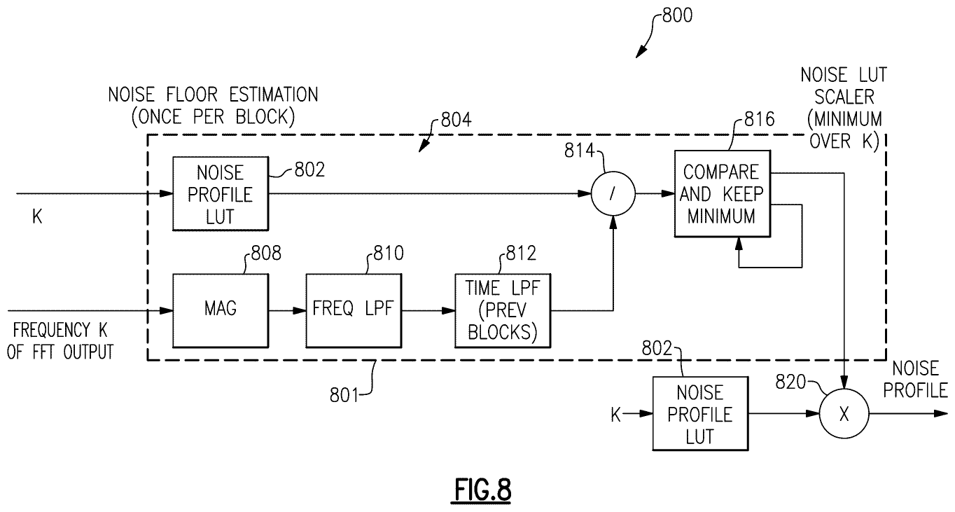

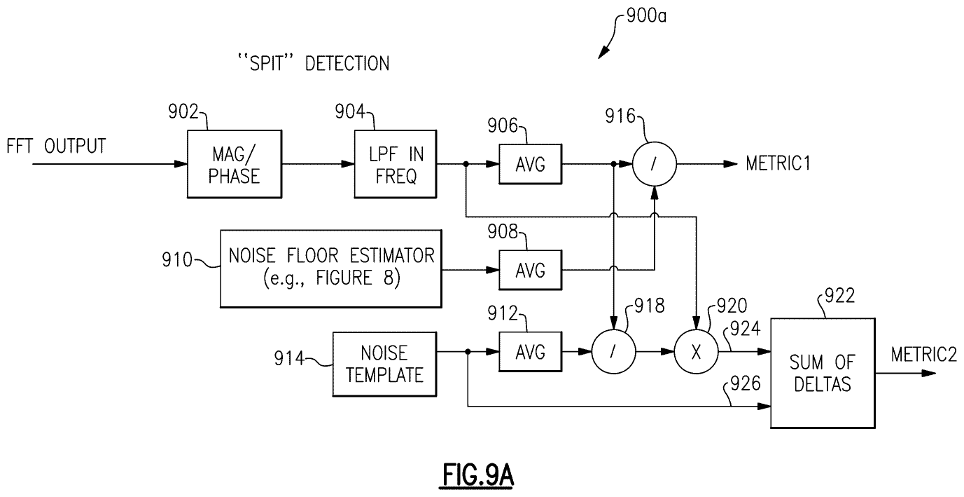

FIG. 8 shows an example of a noise floor estimator 800 that can be used in a spit reduction process. For example, the noise floor estimator 800 can be included in a spectral processing block, such as the spectral processing block 214 of FIG. 3. The noise estimator 800 can include a scaler generator 801 that generates a noise LUT scaler. The scaler generator 801 can be generally the same as the scaler generator 400 of FIG. 4, for example. The minimum scaler output by the scaler generator 801 represents the noise floor of the one frequency that may not have additional signal imposed thereon, or that may have relatively little additional signal imposed thereon, for example, and therefore represents a relatively accurate indication of the noise floor for that frequency bin.

The noise floor estimator 800 uses the scaler to scale the entire noise template for that time block of FFT outputs to get values that represent the noise floor for all frequencies. For instance, the noise floor estimator 800 of the illustrated embodiment estimates the noise floor profile for the current block of FFT samples across all frequencies by multiplying (820) the output of the noise profile LUT 802 with the minimum scaler determined by the scaler generator 801 for the current block of FFT samples.

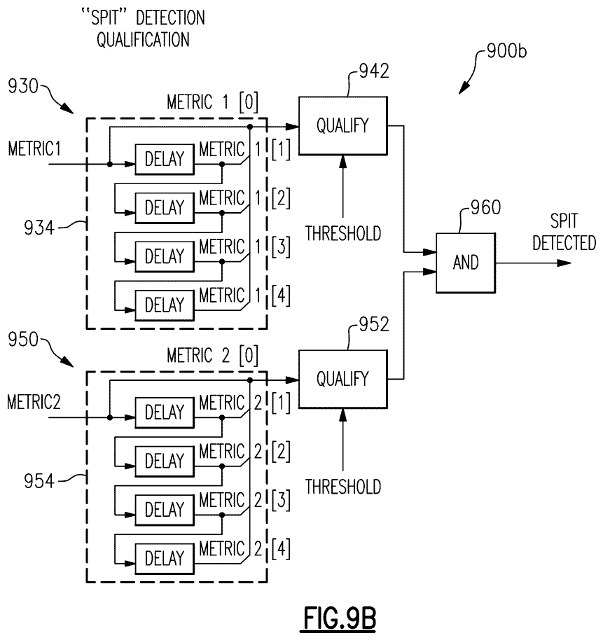

FIG. 9A illustrates an example of a first portion 900a of a spit detector. The spit detector can form a part of a spectral processing block, such as the spectral processing block 214 of FIG. 3, and can work together with a noise estimator, such as the noise estimator 800 of FIG. 8, and/or any of the other noise estimation components and methods described herein, e.g., with respect to FIGS. 3-7.

The first portion 900a of the spit detector takes (902) the magnitudes of the frequency-domain samples output by the FFT, and applies a low pass filter 904 in frequency. The first portion 900a of the spit detector additionally calculates (906) the average of the low pass filtered samples of the FFT outputs.

In parallel, the spit detector calculates (908) the average of the noise floor estimates output by the noise floor estimator 910, which may be the noise floor estimates output by the noise floor estimator 800 of FIG. 8 (e.g., the output of the multiplier 820), for example.

The spit detector additionally calculates (912) the average of the output of the noise profile template 914. For example, the noise profile template 914 may be the same noise profile LUT 802 of FIG. 8, and the output of the noise profile template 914 may be an entry in the noise profile template 914 that corresponds to a current frequency bin K of the FFT output for the current block of samples.

The first portion 900a of the spit detector calculates two metrics based on the frequency domain samples filtered by the low pass filter 904.

In calculating the first metric (metric 1), the spit detector averages (906) the filtered samples and calculates (916) the ratio of the average (906) of the low pass filtered magnitudes of the samples to the average (908) of the noise floor at higher frequencies output by the noise floor estimator 910. The average (908) of the output by the noise floor estimator 910 are at higher frequencies than the average (906) of the low-pass filtered samples because the samples output by the noise floor estimator 910 have not been low-pass filtered.

In calculating the second metric (metric 2), the spit detector calculates the deviation of the shape of the low pass filtered FFT output magnitudes to the output of the noise profile template 914. For instance, the spit detector takes the ratio (918) of the average (906) of the magnitudes of the low-pass filtered FFT outputs and the average (912) of the output of the noise profile template 914, multiples (920) the ratio (918) by the magnitudes of the low-pass filtered samples to generate a representation 924 of the shape of the low-pass filtered magnitudes. The spit detector can then perform a sum of deltas function 922 comparing the representation 924 of the shape of the low-pass filtered magnitudes and the output 926 of the noise profile template 914, thereby generating a representation (metric 2) of the deviation of the shape of the low-pass filtered FFT magnitudes from the noise profile template 914.

According to certain embodiments, the spit detector detects a “spit” when a relatively short-time event occurs that matches the noise profile 914. The spit detector can determine that a short-time event has occurred based on metric 1. For example, the spit detector can determine that a short-time event has occurred if the spit detector determines that metric 1 increases in value by a certain amount, e.g., approximately doubles, and then returns to approximately the original value within a certain number of time blocks, e.g., within a few (e.g., 3, 4, or 5) time blocks. Moreover, the matching of the spectrum to noise can be determined by a smaller deviation of the scaled filtered spectrum to the noise template 914.

FIG. 9B shows a second portion 900b of the spit detector. The illustrated second portion 900b is generally configured to process the first and second metrics (metric 1 and metric 2) calculated by the first portion 900a of the spit detector to determine whether to qualify an event as a detected spit.

The second portion 900b includes a first branch 930 configured to process metric 1 and a second branch 950 configured to process metric 2.

The first branch 930 includes a time delay unit 934 configured to store one or more past calculated values of metric 1. For example, the illustrated time delay unit 934 includes four storage elements daisy-chained together, thereby providing the most recent five instances metric 1[0:4] of metric 1 to a first qualify block 942, where metric 1[0] is the current instance and metric 1[4] is an instance of metric 1 delayed by four blocks, from four blocks in the past.

The first qualify block 942 outputs a ‘1’ indicating that a short time event has been detected based on metric 1 if a threshold condition is triggered. Otherwise, the first qualify block 942 outputs a ‘0’ indicating that no qualified short time event has been detected. For example, in some embodiments, the threshold condition is triggered if the value of metric 1[0] and the value of metric 1[4] are both less than half or less than approximately half of the max of the values of metric 1[1], metric 1[2], and metric 1[3], indicating a transient spike. In some embodiments, threshold condition can be adjustable, e.g., by a user or dynamically based on a machine learning algorithm.

Similarly, the second branch 950 includes a time delay unit 954 configured to store one or more past calculated values of metric 2. For example, the illustrated time delay unit 954 includes four storage elements daisy-chained together, thereby providing the most recent five instances metric 2[0:4] of metric 2 to a second qualify block 952, where metric 2[0] is the current instance and metric 2[4] is the instance of metric 1 delayed by four blocks, from four blocks in the past.

The second qualify block 952 outputs a ‘1’ indicating that a short time event has been detected based on metric 2 if a threshold condition is triggered. Otherwise, the second qualify block 942 outputs a ‘0’ indicating that no qualified short time event has been detected. For example, the short-term event can be qualified if the value of metric 2[2] is less than a threshold amount, which can indicate that the spectral profile of the event closely matches the basic noise profile (e.g., the noise template 914) of the receiver.

If both the first qualify branch 930 and the second qualify branch 950 output a ‘1’, indicating that both metric 1 and metric 2 indicate short time events have been detected, the AND block 960 outputs an indication that a spike has been detected, indicating presence of spit noise.

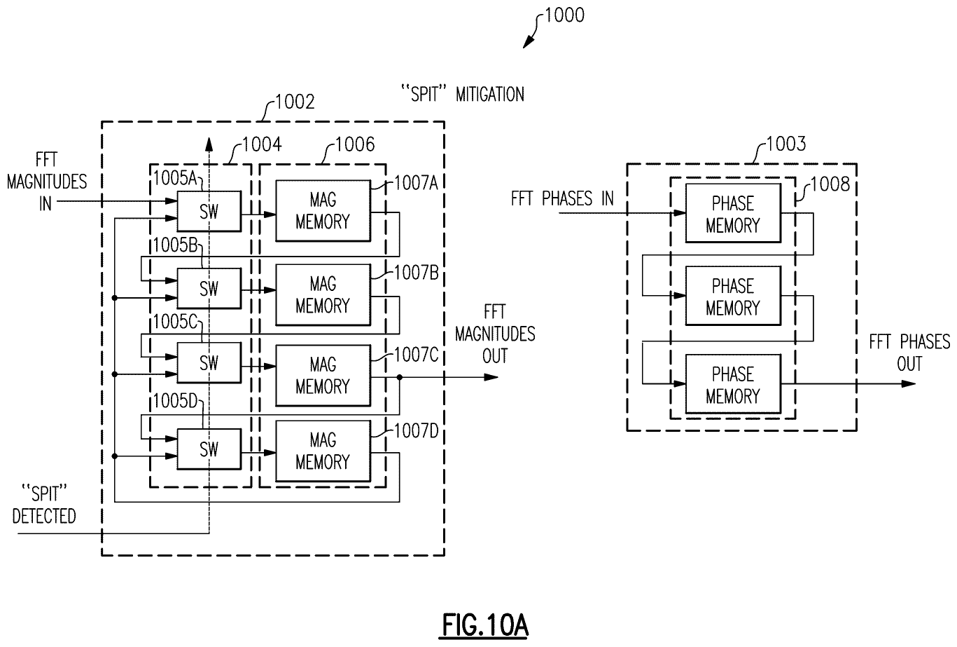

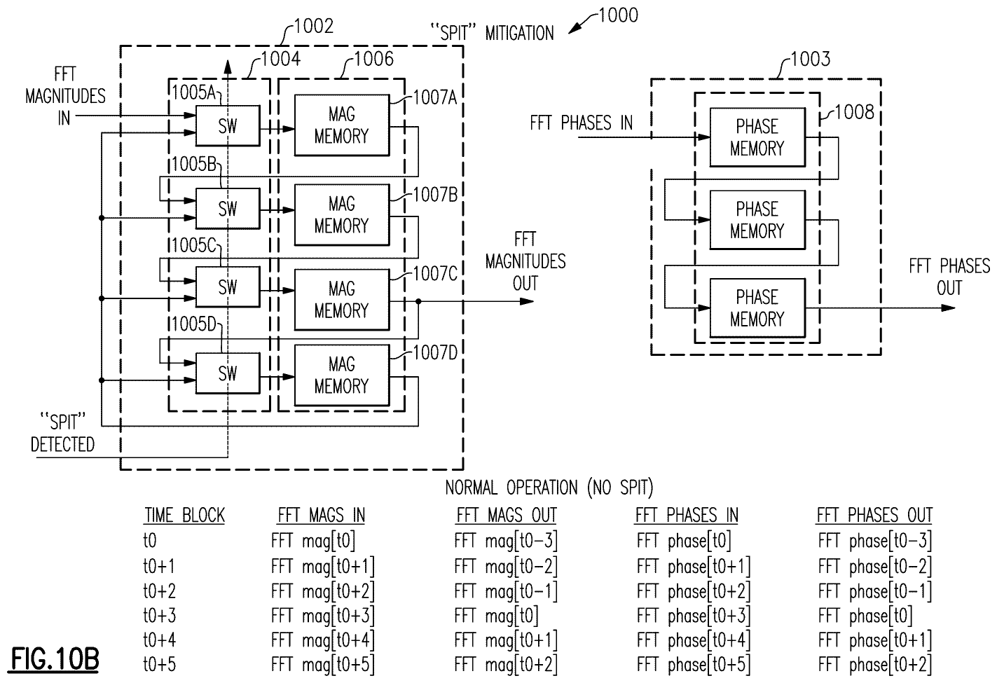

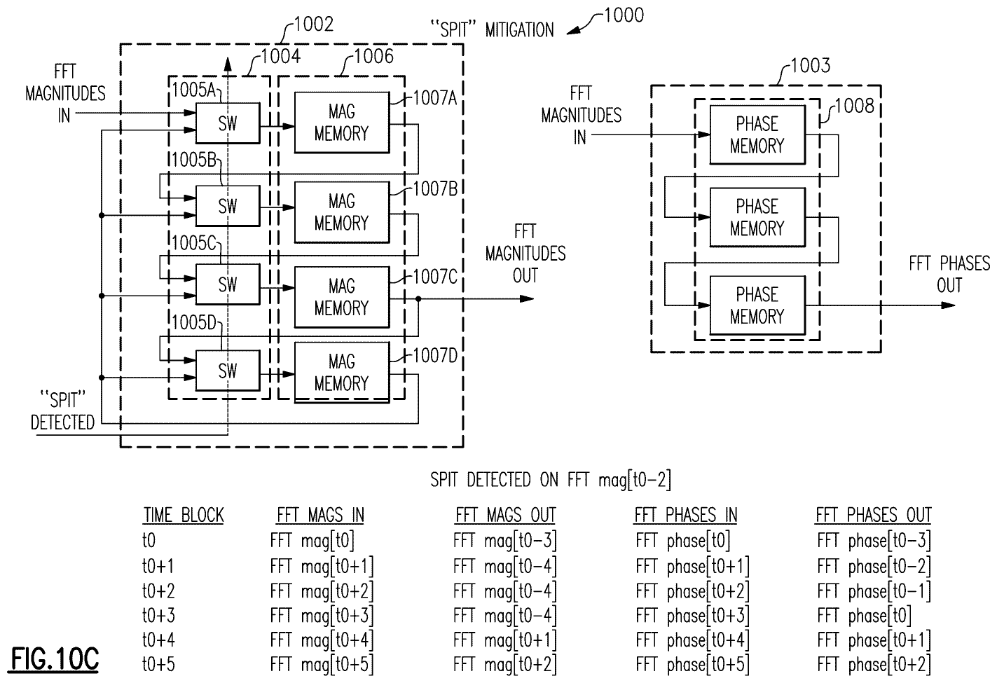

FIG. 10A shows a spit mitigator 1000. The spit mitigator 1000 can form a part of a spectral processing block, such as the spectral processing block 214 of FIG. 3, and can work together with a noise estimator, such as the noise estimator 800 of FIG. 8 and a spit detector, such as the spit detector of FIGS. 9A-9B, and/or any of the other noise estimation components and methods described herein, e.g., with respect to FIGS. 3-7.

For example, the spit mitigator 1000 can receive the “spit detected” output of the second portion 900b of the spit detector of FIG. 9B. The spit mitigator 1000 includes a magnitude processing unit 1002 configured to receive FFT magnitudes for the frequency domain samples corresponding to the current block of FFT samples and a parallel phase processing unit 1003 configured to receive the FFT phases for the same block.

The magnitude processing unit 1002 includes a set of multiplexers 1004 connected to a set of memory elements 1006. Each of the multiplexers 1005A-1005D in the set 1004 of multiplexers receives the “spit detected” value as a control input. As shown, there are four memory elements 1007A-1007D in the set of memory elements 1006 that are daisy chained together.

The output of the third memory element 1007C is provided as an output (“FFT MAGNITUDES OUT”) of the magnitude processing unit 1002. Each multiplexer 1005A-1005D in the set 1004 of multiplexers is connected to the a corresponding memory element 1007A-1007D of the set 1006 of memory elements such that, during normal operation where no spit is detected (e.g., “spit detected”=0), each multiplexer 1005A-1005D in the set 1004 of multiplexers provides the value present on its first (top) input to the corresponding memory element 1007A-1007D to which that multiplexer 1005A-1005D is connected. Thus, during normal operation, the magnitude processing unit 1002 outputs the received stream of FFT magnitudes, but delayed by three blocks.

On the other hand, when the “spit detected” value indicates that a spit has been detected (e.g., “spit detected”=1), each multiplexer 1005A-1005D in the set of multiplexers 1004 provides the value present on its second (bottom) input to the memory element 1007A-1007D to which the multiplexer 1005A-1005D is connected. As shown, the output of the fourth memory element 1007D is connected to the second (bottom) input of each of the multiplexers 1005A-1005D. Thus, when a spit is detected, the magnitude from a previous FFT block is copied into each of the memory elements 1007A-1007D, effectively writing over the blocks of FFT that contain the “spit” with FFT values from a block that came before the spit. The effect of this can be to mask the broadband nature of the “spit”, making it less noticeable. According to some embodiments, the spit is detected based on the FFT data that is currently present at the first input to the third multiplexer 1005C of the set 1004 of multiplexers. For example, a spit detector such as the one shown and described with respect to FIGS. 9A-9B can detect the spit based on the FFT magnitudes currently present at the first input to the third multiplexer 1005C of the set 1004 of multiplexers. This means that when a spit is detected based on the data at the first input to the third multiplexer 1005C, data that is present at the input to the fourth multiplexer 1005D, i.e., data from two blocks prior to the spit, will be copied into the each of the memory elements 1007A-1007D. Thus, in such an implementation, FFT data from the block in which the spit was detected, as well as FFT data from each of the two blocks following the block in which the spit was detected, will be copied over (masked) by FFT data from an FFT block two blocks prior to the spit.

The phase processing unit 1003 includes a daisy chained set of three memory elements 1008 to match the delay of the magnitude processing unit 1002 while retaining the phases. Unlike the magnitudes, the phases in the illustrated embodiment are retained and not written over, regardless of whether a spit is detected. This can be beneficial because the original phase is more likely to be correct for the frequencies present than the phases of the previous FFT blocks, even in the presence of a spit.

FIG. 10B illustrates operation of the spit mitigator 1000 during normal operation where no spit is detected. The table at the bottom of the page shows, for each of six sequential time blocks from t0 to t0+5, the state of 1) the input of the FFT of the magnitude processing unit (“FFT Mags In”), 2) the output of the magnitude processing unit 1002 (“FFT Mags Out”), 3) the input of the phase processing unit 1003 (“FFT Phases In”), and 4) the output of the phase processing unit 1003 (“FFT Phases Out”) of the phase processing unit 1003. As shown, during normal operation the spit mitigator 1000 serially outputs the input magnitude and phase values, delayed by three blocks.

FIG. 10C, on the other hand, illustrates operation of the spit mitigator 1000 over the course of six time blocks t0 to t0+5 for a scenario where a spit is detected on FFT data FFT mag[t0−2] from time block t0−2 that is two time blocks prior to time block t0. In the illustrated embodiment, the spit is detected based on the data present at the first input to the third multiplexer 1005C. Thus, at the time the spit is detected, 1) FFT mag[t0−2] is present at the first input to the third multiplexer 1005C, 2) FFT mag[t0] is present at the input to the magnitude processing unit 1002, which is also the first input to the multiplexer 1005A (“FFT Magnitudes In”), 3) FFT mag[t0−1] is present on the first input to the second multiplexer 1005B, 4) FFT mag[t0−3] is present at the output (“FFT Magnitudes Out”) of the magnitude processing unit 1002, which is also connected to the first input to the fourth multiplexer 1005D. Moreover, FFT mag[t0−4] is present at the output of the fourth memory unit 1007D of the set of memory units 1006, which is also connected to the second input of each of the multiplexers 1005A-1005D. Because, at the time the spit is detected, the output of the fourth memory element 1007D of the set of memory elements 1006 is connected to the second input of each multiplexer 1005A-1005D in the set of multiplexers 1004, actuation of the “spit detected” signal causes each multiplexer 1005A-1005D to present the value FFT mag[t0−4] to its corresponding memory element 1007A-1007D, causing each memory element 1007A-1007D to copy FFT mag[t0−4] to its output. Because the value FFT mag[t0−4] corresponds to a time block t0−4 two time blocks prior to the time block t0−2 in which the spit was detected, FFT mag[t0−4] corresponds to an FFT output that is unaffected by the spit. As shown in the table, copying FFT mag[t0−4] into the memory elements 1007A-1007D causes that pre-spit value FFT mag[t0−4] to be output for three sequential time blocks t0+1, t0+2, and t0+3. Moreover, the actual FFT magnitudes for the time block corresponding to the detected spit and the two time blocks after the detected spit, i.e., time blocks t0−2, t0−1, and t0, which are more likely to be affected by the spit, will be masked, thereby reducing the impact of the spit. At time block t0+4, the magnitude processing unit 1002 will have “flushed out” out the spit, and will output the value FFT mag[t0+1].

As shown, in the illustrated embodiment, the phase processing element 1003 sequentially outputs the phase outputs corresponding to the phase inputs without modification. The phase processing element 103 includes a set of three memory elements 1008. Thus, the phase processing element 103 can be configured to delay the FFT phases by the same amount as the magnitude processing element 102, thereby synchronize the FFT magnitudes and FFT phases output by the spit mitigator 1000.

Adaptive Noise Reduction with Soft Mute Functionality

According to certain embodiments, a soft mute feature reduces the audio level of noisy signals, thereby reducing the loudness of the audio signal when the signal is relatively noisy. This technique can be synergistic with the adaptive noise suppression techniques described herein, including any of those described with respect to FIGS. 2-10.

For instance, the audio signal can in some circumstances become so noisy that adaptive or additional adaptive noise suppression does not provide objectively better sounding audio. In such cases, using soft mute functionality can give the listener relief from the noisy signal, while also not aggressively altering the signal. This can result in audio with a more natural noise sound, while reducing the volume level of the noise.

According to certain embodiments, the amount of adaptive noise suppression applied can be dependent or linked to how much soft mute is applied, and vice versa. By linking the adaptive noise suppression and the soft mute in such a fashion, the system can provide the user with an improved audio experience in which the noise stays at a relatively constant or audibly acceptable level.

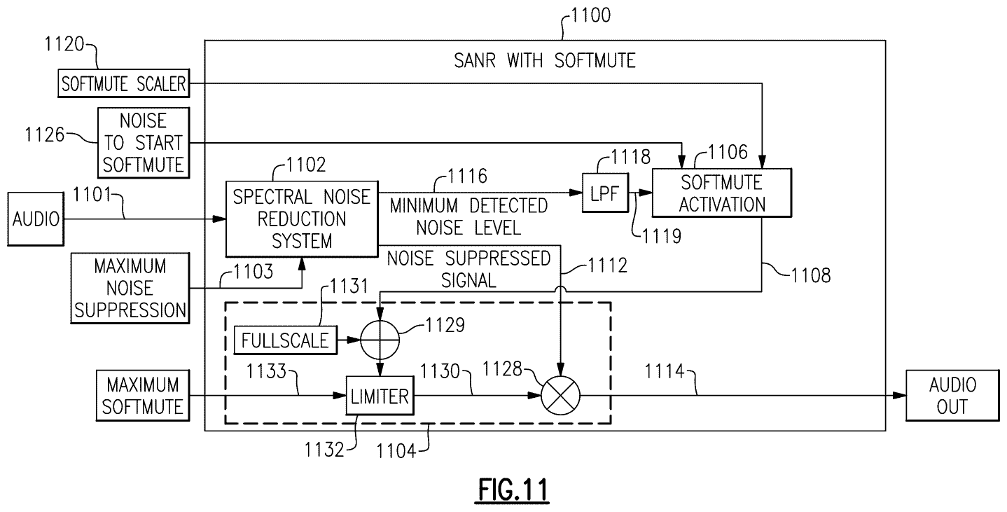

FIG. 11 shows an example of an audio processing system 1100 that employs adaptive noise suppression and soft mute. For example, the audio processing system 1100 can be implemented in the audio processing system 110 of FIG. 2 and can form part of the spectral noise reduction system 202 of FIG. 2 and/or the spectral processing system 214 of FIG. 3.

The audio processing system 1100 includes an spectral noise reduction system 1102, which can be any of the adaptive noise reduction systems described herein, such as the spectral noise reduction system 202 of FIG. 2. For instance, the adaptive noise reduction system 1102 can implement any of the noise reduction functionality described herein, including with respect to FIGS. 2-10, and thereby apply spectral noise reduction to the input audio signal 1101 to output a noise suppressed audio signal 1112.

The illustrated spectral noise reduction system 1102 receives a maximum noise suppression input 1103, which can set a maximum amount of noise suppression the spectral noise reduction system 1102 will apply to any frequency bin of the input audio signal 1101. The maximum noise suppression can be 6 dB, 12 dB, 24 dB, a value between any of the foregoing values, or more, depending on the embodiment. Thus, the noise suppressed audio signal 1112 will have a maximum amount of noise suppression for any given frequency bin of the audio signal corresponding to the value of the maximum noise suppression input 1103 (e.g., 10 dB).

The audio processing system 1100 further includes a soft mute attenuation block 1104 controlled by a soft mute activation block 1106. For example, in the illustrated embodiment, the soft mute activation block 1106 provides the soft mute attenuation block 1104 a control signal 1108. In response to the control signal 1108, the soft mute attenuation block 1104 processes the noise-suppressed audio output signal 1112 provided by the spectral noise reduction system 1102 and provides an output audio signal 1114.

In some embodiments, if the control signal 1108 provide by the soft mute activation block 1106 indicates that soft mute should not be applied, the soft mute attenuation block 1104 passes the noise-suppressed audio output signal 1112 provided by the spectral noise reduction system 1102 in unmodified form, and therefore provides an audio output signal 1114 that is identical to the noise-suppressed audio output signal 1112.

If, on the other hand, the output of the soft mute activation block 1106 indicates that soft mute should be applied, the soft mute attenuation block 1104, in response to the soft mute control signal 1108, attenuates or otherwise modifies the noise-suppressed audio signal 1112 provided by the spectral noise reduction system 1102. For example, the soft mute attenuation block 1104 may apply a flat attenuation or volume reduction across all frequencies of the audio signal, where the amount of attenuation is based on a value of the soft mute control signal 1108.

The spectral noise reduction system 1102 outputs a minimum detected noise level 1116 detected by the spectral noise reduction system 1102. For example, the minimum noise level 1116 may correspond to the noise LUT scalers output by the block 416 of FIG. 4, and can correspond to the estimated noise floor across frequencies of the input signal 1101. A low pass filter 1118 filters out the minimum noise level 1116 across higher frequencies and outputs the minimum noise level across lower frequencies of the input audio signal 1101 to generate a low pass filtered minimum detected noise level 1119.

The soft mute activation block 1106 compares (e.g., differences) the filtered minimum detected noise level 1119 to a soft mute activation threshold 1126 (“noise to start soft mute”) that corresponds to a threshold amount of noise detected by the spectral noise reduction system 1102 beyond which the soft mute activation block 1106 will activate soft mute. If the comparison indicates that the filtered minimum detected noise level 1119 is higher than the soft mute activation threshold 1126, the soft mute activation block 1106 multiples the difference between the filtered minimum detected noise level 1119 and the soft mute activation threshold 1126 by a soft mute scalar 1120, and outputs the result of the multiplication as the soft mute control signal 1108. In this manner, the magnitude of the soft mute control signal 1108 will change based on the filtered minimum detected noise level 1119, and can be used to cause the soft mute attenuation block 1104 to apply a varying amount of soft mute for changing noise floors. In some embodiments, the soft mute threshold 1126 is the same as the value of the maximum noise suppression input 1103 (e.g., 10 dB).

The soft mute attenuation block 1104 of the illustrated embodiment adds (1129) the control signal 1108 to a “fullscale” value 1131, for example, such that the attenuation factor becomes a multiplicative scalar even when the control signal is negative (e.g., when soft mute is to be applied). A limiter 1132 receives the output of the addition operation 1129 and outputs an attenuation factor 1130 corresponding to an amount of soft mute attenuation that should be applied to the noise-suppressed audio signal 1112. The limiter 1132 also receives a maximum soft mute value 1133 and will limit the attenuation factor 1130 based on the maximum soft mute value 1133, thereby limiting the amount of soft mute that can be applied by the soft mute attenuation block 1104.

If soft mute is not activated (filtered minimum noise detected 1119 is less than the soft mute threshold 1126), the attenuation factor 1130 output by the soft mute attenuation block is one, and the output audio signal 1114 provided by the multiplier 1128 will be an unmodified copy of the noise suppressed audio signal 1112, resulting in no soft mute and only spectral noise reduction. If, on the other hand, soft mute is activated (filtered minimum noise detected 1119 greater than the soft mute threshold 1126), the attenuation factor 1130 will be a value less than one, with smaller values corresponding to a higher minimum detected noise level 1119, and the output audio signal 1114 provided by the multiplier 1128 will be an attenuated version of the noise reduced signal 1112, limited by the maximum soft mute value 1133.

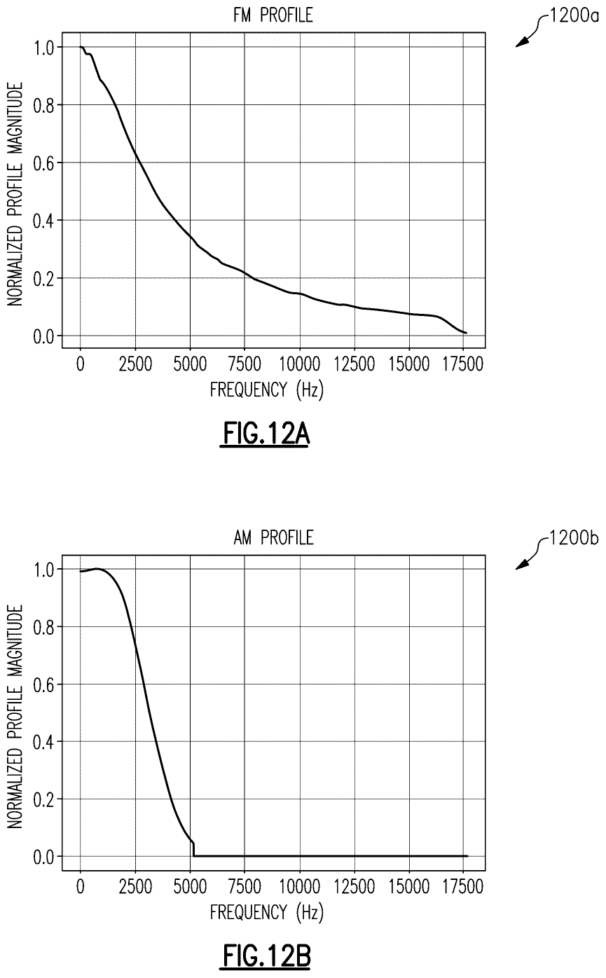

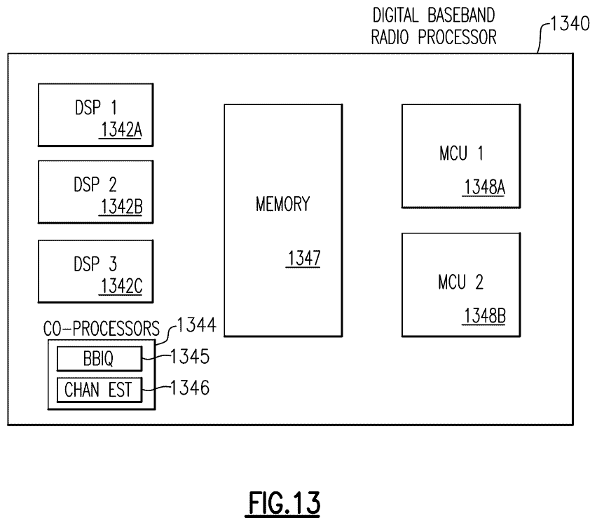

FIG. 12A illustrates an example of a plot 1200a of a noise profile for a radio component configured to process a frequency modulated (FM) signal. For example, the plot 1200a may be that of a noise profile of a demodulator of an FM tuner of a receiver system, such as the demodulator 103 of the receiver system 200 of FIG. 2.

FIG. 12B illustrates an example of a plot 1200b of a noise profile for a radio component configured to process an amplitude modulated (AM) signal. For example, the plot 1200b may be that of a noise profile of a demodulator of an AM tuner of a receiver system, such as the demodulator 103 of the receiver system 200 of FIG. 2.

According to certain embodiments, a noise profile corresponding to the plot 1200a of FIG. 12A or the plot 1200b to FIG. 12B may be represented by the tables stored in the noise profile LUTs described herein, such as, for example, any of the noise profile LUTs 402, 510, 802, 818, 914 of FIG. 4, 5, 8, or 9, respectively.

FIG. 13 is a schematic block diagram of a radio baseband processor 1340 according to an embodiment. As illustrated, the radio baseband processor 1340 includes a plurality of DSPs 1342A, 1342B, 1342C, a plurality of co-processors 144 including a baseband IQ (BBIQ) co-processor 1345 and a channel estimation co-processor 1346, a memory 1347, and microcontrollers (MCUs) 1348A and 1348B.

In certain applications, any of the noise reduction techniques disclosed herein can be implemented in a single DSP 1342A with help from the BBIQ co-processor 1345 and the channel estimation co-processor 1346 in the radio baseband processor 1340. In some other applications, the noise reduction techniques disclosed herein can be implemented in an application specific integrated circuit (ASIC) or a hardware accelerator.

The disclosed noise reduction techniques have been described primarily in connection with analog radio standards such as AM and FM, and may have the most significant impact in reducing noise in analog signals. However, in alternative implementations, noise reduction disclosed can be implemented in DAB radio system firmware and can be applied to digital radio standards, including, but not limited to, NRSC-5C, DRM, and CDR. Noise reduction disclosed herein is applicable to suitable OFDM standards including, but not limited to, WiFi and/or other IEEE 802.11 standards, Long Term Evolution (LTE), Digital Video Broadcasting-Terrestrial (DVB-T), etc.

Any of the embodiments described above can be implemented in radio systems. The principles and advantages of the embodiments can be used for any systems or apparatus, such as any radio receiver, that could benefit from any of the embodiments described herein. The teachings herein are applicable to a variety of systems. In certain applications, radio systems disclosed herein are implemented in vehicles such as automobiles. Although this disclosure includes some example embodiments, the teachings described herein can be applied to a variety of structures.

Aspects of this disclosure can be implemented in various electronic devices. Examples of the electronic devices can include, but are not limited to, consumer electronic products, parts of the consumer electronic products, radio receivers, wireless communication infrastructure, electronic test equipment, etc. Examples of the electronic devices can include, but are not limited to, a stereo system, a digital music player, a radio, a vehicular electronics system such as an automotive electronics system, etc. Further, the electronic devices can include unfinished products.

Unless the context indicates otherwise, throughout the description and the claims, the words “comprise,” “comprising,” “include,” “including” and the like are to generally be construed in an inclusive sense, as opposed to an exclusive or exhaustive sense; that is to say, in the sense of “including, but not limited to.” Conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively.

While certain embodiments have been described, these embodiments have been presented by way of example only, and are not intended to limit the scope of the disclosure. Indeed, the methods, systems, and circuits described herein may be embodied in a variety of other forms. Furthermore, various omissions, substitutions, and changes in the form of the methods, systems, and circuits described herein may be made without departing from the spirit of the disclosure. Any suitable combination of the elements and/or acts of the various embodiments described above can be combined to provide further embodiments. The accompanying claims and their equivalents are intended to cover such forms or modifications as would fall within the scope and spirit of the disclosure.

What is claimed is:

1. A radio receiver with noise suppression comprising:
a Fourier transform engine configured to convert a time domain audio signal into frequency domain blocks; and
a spectral processing engine configured to use a stored noise profile corresponding to a component of the radio receiver to generate noise floor estimates for the frequency domain blocks and further configured to, for each respective frequency domain block of the frequency domain blocks, use the noise floor estimate for the respective frequency domain block to adjust an output of the stored noise profile to generate a noise estimate for the respective frequency domain block across frequencies, and to use the noise estimate to adjust magnitudes of the respective frequency domain block across frequencies, thereby suppressing noise in the audio signal.

2. The radio receiver of claim 1 further comprising an inverse Fourier transform engine configured to transform the frequency domain blocks into a time domain signal.

3. The radio receiver of claim 1 wherein the spectral processing engine is configured to generate the noise floor estimate by, for frequency bins across the respective frequency domain block, calculating a value that is a function of (1) an entry in the stored noise profile corresponding to the frequency bin, and (2) a magnitude of the respective frequency domain block for the frequency bin, and to identify the calculated value for one of the frequency bins as the noise floor estimate for the respective frequency domain block.

4. The radio receiver of claim 3 wherein the magnitude of the respective frequency domain block used in the calculation is low pass filtered.

5. The radio receiver of claim 1 wherein the spectral processing engine is configured to adjust the noise floor estimate based on a tonality metric derived from magnitudes of the respective frequency domain block.

6. The radio receiver of claim 5 wherein the tonality metric corresponds to a sum of squares of the magnitudes of the respective frequency domain block divided by a square of sums of the magnitudes of the respective frequency domain block.

7. The radio receiver of claim 1 wherein the spectral processing engine is further configured, for each frequency bin of each respective frequency domain block, to:
filter the magnitude of the respective frequency domain block in time and frequency to generate a filtered magnitude; and
attenuate the magnitude of the respective frequency domain block according to a function of (1) the noise floor estimate for the frequency bin and (2) the filtered magnitude, thereby suppressing noise in the audio signal.

8. The radio receiver of claim 1 wherein the spectral processing engine is further configured to, in response to determine that a signal-to-noise ratio metric is below a threshold, generate the noise floor estimates for the frequency domain blocks according to an alternative technique without using the stored noise profile.

9. The radio receiver of claim 1 wherein the stored noise profile corresponds to a demodulator of the radio receiver.

10. A radio system including at least one antenna configured to receive a radio signal and a radio receiver of any claim 1.

11. A method of suppressing noise in an audio signal of a radio receiver, the method comprising:
transforming a demodulated time-domain audio signal into frequency domain blocks;
in the radio receiver, using a stored noise profile corresponding to a component of the radio receiver to generate noise floor estimates for the frequency domain blocks;
using the noise floor estimate for each frequency domain block to adjust an output of the stored noise profile to generate a noise estimate for the frequency domain block across frequencies; and
using the noise estimate for each frequency domain block to adjust magnitudes of the frequency domain block across frequencies, thereby suppressing noise in the audio signal.

12. The method of claim 11 wherein generating the noise floor estimate includes:
for frequency bins across the frequency domain block, calculating a value that is a function of (1) an entry in the stored noise profile corresponding to the frequency bin, and (2) a magnitude of the frequency domain block for the frequency bin;
identifying the calculated value for one of the frequency bins as the noise floor estimate for the frequency domain block.

13. The method of claim 11 further comprising adjusting the noise floor estimate based on a tonality metric derived from magnitudes of the frequency domain block.

14. The method of claim 13 wherein the tonality metric corresponds to a sum of squares of the magnitudes of the frequency domain block divided by a square of sums of the magnitudes of the frequency domain block.

15. The method of claim 11 further comprising for each frequency bin of each frequency domain block:
filtering the magnitude of the frequency domain block in time and frequency to generate a filtered magnitude; and
attenuating the magnitude of the frequency domain block according to a function of (1) the noise floor estimate for the frequency bin and (2) the filtered magnitude, thereby suppressing noise in the audio signal.

16. The method of claim 11 further comprising, in response to determining that a signal-to-noise ratio metric is below a threshold, generating the noise floor estimates for the frequency domain blocks according to an alternative technique without using the stored noise profile.

17. The method of claim 11 wherein the stored noise profile corresponds to a demodulator of the radio receiver.

18. A radio receiver with noise floor estimation, the radio receiver comprising:
a Fourier transform engine configured to convert a time domain audio signal into frequency domain blocks; and
a spectral processing engine configured, for each frequency domain block, to generate a noise floor estimate using both (1) a stored noise profile corresponding to a component of the radio receiver and (2) magnitudes of the frequency domain block.

19. The radio receiver of claim 18 wherein the spectral processing engine is further configured to generate the noise floor estimate by: for each frequency bin within the frequency domain block, calculating a value that is a function of (1) an entry in the stored noise profile corresponding to the frequency bin, and (2) a magnitude of the frequency domain block for the frequency bin, and identifying the calculated value for one of the frequency bins as the noise floor estimate for the frequency domain block.

20. The radio receiver of claim 18 wherein the spectral processing engine is further configured to adjust the noise floor estimate based on a tonality metric derived from magnitudes of the frequency domain block.
